(19) United States
(12) Patent Application Publication
(10) Pub. No.: US 2024/0100885 A1
(43) Pub. Date: Mar. 28, 2024

(54) Optimized Architecture of a Civil Engineering Tire

(71) Applicant: COMPAGNIE GENERALE DES ETABLISSEMENTS MICHELIN, Clermont-Ferrand (FR)

(72) Inventors: Jean-Luc GUERBERT-JUBERT, Clermont-Ferrand Cedex 9 (FR); François BARBARIN, Clermont-Ferrand Cedex 9 (FR); Olivier REIX, Clermont-Ferrand Cedex 9 (FR); Philippe MANSUY, Clermont-Ferrand Cedex 9 (FR); Lucas LAUBY, Clermont-Ferrand Cedex 9 (FR); Sébastien NOEL, Clermont-Ferrand Cedex 9 (FR)

(21) Appl. No.: 18/266,928

(22) PCT Filed: Dec. 9, 2021
(86) PCT No.: PCT/FR2021/052263

§ 371 Date: Jun. 13, 2023

(30) Foreign Application Priority Data
Dec. 15, 2020 (FR) 2013266

(51) Int. Cl. B60C 9/20; B60C 9/00

(52) U.S. Cl. CPC B60C 9/2006; B60C 9/0007; B60C 2009/0078; B60C 2009/2016; B60C 2009/2019

(57) ABSTRACT

A radial tire (1) for a heavy-duty vehicle, with at least two working layers (321, 322, 323, 324) in which the reinforcing elements form an angle at least equal to 10° and at most equal to 45° with the circumferential direction. The metal reinforcers of all of the crown layers of the crown reinforcement are extensible and therefore have, in their rubberized state extracted from a polymer matrix, a structural elongation As at least equal to 0.5%, a total elongation at break At at least equal to 3% and a tensile Young's modulus E at most equal to 150 GPa. The narrower of the two working layers has an axial width at least equal to 60% of the width of the tread and the wider of the two working layers has an axial width at least equal to 70% of the width of the tread.

The present invention relates to a radial tire intended to be fitted to a heavy-duty civil engineering vehicle and more specifically heavy-duty vehicles or loaders for underground mines, and more particularly concerns the crown reinforcement of such a tire.

Radial tires intended to be fitted to a heavy-duty civil engineering vehicle are designated within the meaning of the European Tire and Rim Technical Organisation, or ERTRO, standard.

For example, a radial tire for a heavy-duty civil engineering vehicle, within the meaning of the European Tire and Rim Technical Organisation, or ETRTO, standard, is intended to be mounted on a rim with a diameter at least equal to 25 inches. Although not limited to this type of application, the invention is described for a radial tire with large dimensions intended to be mounted on a loader, a vehicle for transporting materials extracted from underground mines, by means of a rim with a diameter at least equal to 35 inches.

Since a tire has a geometry which exhibits symmetry of revolution about an axis of rotation, the geometry of the tire is generally described in a meridian plane containing the axis of rotation of the tire. For a given meridian plane, the radial, axial and circumferential directions respectively denote the directions perpendicular to the axis of rotation of the tire, parallel to the axis of rotation of the tire and perpendicular to the meridian plane. The circumferential direction is tangential to the circumference of the tire.

Hereinafter, the expressions “radially inside” and “radially outside” respectively mean “closer to” and “further away from the axis of rotation of the tire”. “Axially inside” and “axially outside” respectively mean “closer to” and “further away from the equatorial plane of the tire”, the equatorial plane of the tire being the plane passing through the middle of the tread surface and perpendicular to the axis of rotation.

Generally, a tire comprises a tread intended to come into contact with the ground by means of a tread surface, the two axial ends of which are connected by means of two sidewalls to two beads that provide the mechanical connection between the tire and the rim on which it is intended to be mounted.

A radial tire further comprises a strengthening reinforcement made up of a crown reinforcement radially inside the tread, and a carcass reinforcement radially inside the crown reinforcement.

The carcass reinforcement of a radial tire for a heavy-duty civil engineering vehicle usually comprises at least one carcass layer comprising generally metal reinforcers, or reinforcing elements, that are coated in a polymeric material of the elastomer or elastomeric type obtained by blending and known as a coating compound. A carcass layer comprises a main part that connects the two beads together and is generally wound, in each bead, from the inside of the tire to the outside around a usually metal circumferential reinforcing element known as a bead wire so as to form a turn-up. The metal reinforcers of a carcass layer are substantially parallel to each other and form an angle of between 85° and 95° with the circumferential direction.

The crown reinforcement of a radial tire for a civil engineering vehicle comprises a superposition of crown layers extending circumferentially, radially outside the carcass reinforcement. Each crown layer is made up of generally metal reinforcers that are parallel to each other and coated in a polymeric material of the elastomer or coating compound type.

Among the crown layers, a distinction is usually made between protective layers, which make up the protective reinforcement and are radially outermost, and working layers, which make up the working reinforcement and are radially between the protective reinforcement and the carcass reinforcement.

The protective reinforcement, comprising at least one protective layer, essentially protects the working layers from mechanical or physicochemical attack that might spread through the tread radially towards the inside of the tire.

The protective reinforcement often comprises two radially superposed protective layers formed of extensible metal reinforcers that are parallel to each other in each layer and crossed from one layer to the next, forming angles at least equal to 10° with the circumferential direction.

The working reinforcement, comprising at least two working layers, has the function of belting the tire and conferring stiffness and road holding thereon. It absorbs both mechanical stresses of inflation, which are generated by the tire inflation pressure and transmitted by the carcass reinforcement, and mechanical stresses caused by running, which are generated as the tire runs over the ground and are transmitted by the tread. It must further withstand oxidation, impacts and punctures due to its intrinsic design and the design of the protective reinforcement responsible for protecting the other crown layers from external attack, tears or other punctures.

The working reinforcement usually comprises two radially superposed working layers formed of inextensible metal reinforcers that are parallel to each other in each layer and crossed from one layer to the next, forming angles at most equal to 60°, and preferably at least equal to 10° and at most equal to 45°, with the circumferential direction. For satisfactory absorption of the radial and transverse forces, designers seek to maximize the stiffness and breaking force of the reinforcing elements of the working layers.

In order to reduce the mechanical inflation stresses that are transmitted to the working reinforcement, it is known practice to position a hoop reinforcement radially outside the carcass reinforcement. The hoop reinforcement, the function of which is to at least partially absorb the mechanical stresses of inflation, improves the endurance of the crown reinforcement by stiffening the crown reinforcement. The hoop reinforcement can be positioned radially inside the working reinforcement, between the two working layers of the working reinforcement, or radially outside the working reinforcement.

In civil engineering applications, the hoop reinforcement can comprise two radially superposed hooping layers formed of metal reinforcers, parallel to each other in each layer and crossed from one layer to the next, forming angles at most equal to 10° but at least equal to 5° with the circumferential direction. In this case, the reinforcing elements of the hooping layers are placed in layers and stretch from one axial edge to the other of said hooping layers in less than one revolution of the tire on its axis of rotation.

The hoop reinforcement can usually comprise a hooping layer produced by the circumferential winding of a hooping wire or a continuous hooping strip forming angles at most equal to 5° with the circumferential direction.

With respect to the metal reinforcers, a metal reinforcer is mechanically characterized by a curve representing the tensile force (in N) applied to the metal reinforcer as a function of the relative elongation (as a %) thereof, known as the force-elongation curve. Mechanical tensile characteristics of the metal reinforcer, such as the structural elongation As (as a %), the total elongation at break At (as a %), the force at break Fm (maximum load in N) and the breaking strength Rm (in MPa), are derived from this force-elongation curve, these characteristics being measured in accordance with ASTM D 2969-04 of 2014.

The total elongation at break At of the metal reinforcer is, by definition, the sum of its structural, elastic and plastic elongations (At=As+Ae+Ap) and particularly at break, when each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behavior of the metal following Hooke's law. The plastic elongation Ap results from the plasticity, that is the irreversible deformation beyond the elastic limit, of the metal of these metal threads taken individually. These different elongations and the respective meanings thereof, which are well known to a person skilled in the art, are described, for example, in U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between extensible metal reinforcers, such as those used in the protective layers, and inextensible or non-extensible metal reinforcers, such as those used in the working layers.

An extensible metal reinforcer, in its non-rubberized state, is characterized by a structural elongation As at least equal to 1% and a total elongation at break At at least equal to 3%. In addition, an extensible metal reinforcer has a tensile elastic modulus at most equal to 180 GPa, and usually between 40 GPa and 150 GPa.

In its rubberized state extracted from a polymer matrix, namely a tire, an extensible metal reinforcer is characterized by a structural elongation As at least equal to 0.5% and a total elongation at break At at least equal to 3%. In addition, an extensible metal reinforcer has, in its rubberized state extracted from a polymer matrix, a tensile elastic modulus or Young's modulus at most equal to 150 GPa, and usually between 40 GPa and 120 GPa. The term hyperextensible is used for a metal reinforcer with a structural elongation of between 1% and 3%.

An inextensible metal reinforcer is characterized by a total elongation at break At, under a tensile force equal to 10% of the force at break Fm, at most equal to 0.2%. Moreover, an inextensible metal reinforcer has a tensile elastic modulus, or Young's modulus, usually between 150 GPa and 200 GPa.

When the tire runs on stones or other more or less sharp objects present in the underground mines in which loaders travel, the crown of a tire is frequently subject to cuts that can pass radially through it towards the inside and, depending on the size of the object, puncture the crown reinforcement and carcass reinforcement assembly, creating a loss of pressure and leading to the failure of the tire. The use of extensible metal reinforcers in the protective layers is known to improve the puncture resistance of tires by allowing improved adaptation of said protective layer to the shape of the obstacle; however, given the cost of these large tires and the frequency of these incidents, it is always beneficial to improve performance.

However, while these crown architectures are effective against relatively small or medium-sized obstacles, they are less effective against larger obstacles present in mines. Specifically, in such cases, the forces exerted on the cords are greater than the force at break of the cords and the obstacle therefore “cuts” the reinforcing elements of the working layers, and the stiffer these cords are, and the more they oppose the deformation imposed by the obstacle, the more easily they are cut.

The inventors set themselves the objective, for a radial tire for a civil engineering vehicle, of reducing the risk of the crown of the tire being punctured due to attacks on the tread when running over sharp stones, while retaining good crack resistance performance of the crown and with a reduction in the mass of the crown reinforcement.

This objective has been achieved, according to the invention, by a radial tire for a civil engineering vehicle comprising:
a crown reinforcement, radially inside a tread having an axial width Lbdr and radially outside a carcass reinforcement, and comprising crown layers having metal reinforcing elements,
the crown reinforcement comprising at least one working reinforcement, comprising at least two working layers, one with a larger axial width having an axial width Ltmax and one with a smaller axial width having an axial width Ltmin,
each working layer comprising metal reinforcing elements parallel to each other, forming oriented angles at least equal to 10° and at most equal to 45° with the circumferential direction, at least two angles of two working layers being of opposite signs,
each reinforcing element of each of the crown layers being characterized by a structural elongation As, a force at break Fm (maximum load in N), a breaking strength Rm (in MPa), a total elongation at break At and a tensile Young's modulus E, these characteristics being measured in accordance with ASTM D 2696-04 of 2014,
each metal reinforcing element of each crown layer is extensible and has, in its rubberized state extracted from a polymer matrix, a structural elongation As at least equal to 0.5%, a total elongation at break At at least equal to 3% and a tensile Young's modulus E at most equal to 150 GPa,
the axial width Ltmin of the working layer with a smaller axial width is at least equal to 60% of the axial width Lbdr of the tread (Ltmin≥0.6*Lbdr),
the axial width Ltmax of the working layer with a larger axial width is at least equal to 70% of the axial width Lbdr of the tread (Ltmax≥0.7*Lbdr).

The invention consists of a tire in which all of the metal reinforcers of the crown reinforcement are extensible or hyperextensible, unlike the tires according to the prior art in which at least the working layers are inextensible in order to allow adequate circumferential and transverse stiffness. Surprisingly, on the existing civil engineering tires, this feature is not considered to be essential, and what's more, using extensible cords for the working layers allows for substantial increases in the puncture resistance of the crown and crack resistance, with a possible saving on mass. It is then possible, due to the extensible properties of the reinforcers, to maintain a satisfactory level of shear of the rubber materials, at the ends of the working layers, and a satisfactory crown stiffness, provided that the working layers have a minimum width relative to the width of the tread, typically at least equal to 70% of the width of the tread for the working layer with a larger axial width and at least equal to 60% of the width of the tread for the working layer with a smaller axial width. Below this minimum axial width of the transverse reinforcer layer with a smaller width, the transverse forces are less well absorbed and the mechanical behavior of the tire deteriorates, in particular its crack resistance performance at the axial ends of the transverse reinforcer layers.

The inventors have observed that the invention functions satisfactorily with or without hooping layers. However, hooping layers with reinforcers that are strictly circumferential generate manufacturing constraints due to their low deformation capacity; it is thus advantageous not to use them. This is not the case if the extensible reinforcers of the hooping layers, if used, form an angle at least equal to 5° with the circumferential direction measured at the circumferential mid-plane. A crown layer comprising extensible or hyperextensible reinforcers forming an angle at least equal to 45° and at most equal to 70° with the circumferential direction can also be associated with the working layers, and is known as the triangulation layer. This type of reinforcer layer has the benefit of opposing shear between the at least two working layers and also of absorbing the compressive forces usually absorbed by the carcass reinforcement. Different extensible reinforcers can also be used between the triangulation layer and the working layers, in particular so that the radially outermost working layer is more extensible and protects the others in the event of an impact on the crown.

The invention can therefore be implemented in a plurality of embodiments with two, three, four or more working layers, the angles of which have opposite signs from one working layer to the next, or in pairs having different signs from one layer to the next in each pair, optionally associated with one or two hooping layers in which the reinforcers form an angle at least equal to 5° and at most equal to 10° with the circumferential direction, optionally associated with a triangulation layer in which the reinforcers form an angle at least equal to 45° and at most equal to 70° with the circumferential direction. The radially outermost working layer can be significantly more extensible than the radially innermost working layer.

Among all of the possible solutions, the crown reinforcement advantageously consists of two working layers, in particular in order to save raw material resources.

For reasons of saving raw materials, the crown reinforcement also advantageously consists of two working layers and a third crown layer in which the extensible metal reinforcers form an angle of between 5° and 70° with the circumferential direction. In this case, the crown consists of two working layers and, depending on the angle selected, a hooping layer, a third working layer, or a triangulation layer.

Again in order to save raw materials, the crown reinforcement advantageously consists of four working layers.

Again in order to save raw materials, the crown reinforcement advantageously comprises three working layers and a transverse reinforcer crown layer in which the extensible reinforcers form an angle of between 5° and 70° with the circumferential direction, the angles of the reinforcers with the circumferential direction being of opposite signs from one working layer to the next. In this case, the crown consists of three working layers and, depending on the angle selected, a hooping layer, a fourth working layer, or a triangulation layer.

One beneficial solution is that the crown reinforcement comprises at least two working layers and two transverse reinforcer layers in which the extensible reinforcers form an angle of between 5° and 10° with the circumferential direction, the angles of these reinforcers with the circumferential direction being of opposite signs from one layer to the next.

In order to protect the crown reinforcement more effectively from impacts, in particular when running over obstacles often present on the ground, if the crown reinforcement comprises at least three crown layers, then the reinforcing elements of the radially outermost crown layer advantageously have a structural elongation Asp at least equal to one percent plus the structural elongation Ast (Asp≥1%+Ast) of the reinforcing elements of the radially innermost working layer, each of the reinforcers being in its rubberized state extracted from a polymer matrix. An advantageous version of the invention comprises a crown reinforcement comprising two layers, the radially outermost layers, in which the reinforcing elements have a structural elongation Asp at least equal to one percent plus the structural elongation Ast (Asp≥1%+Ast) of the reinforcing elements of the radially innermost working layer, each of the reinforcers being in its rubberized state extracted from a polymer matrix.

Preferably, the structural elongation As of the reinforcing elements of each reinforcer layer is at least equal to 85% and at most equal to 110% of the structural elongation Ast of the reinforcing elements of the radially innermost working layer, each of the reinforcers being in its rubberized state extracted from a polymer matrix. Unless the radially outermost reinforcer layer is more extensible, the respective total elongations of the reinforcers of each reinforcer layer are advantageously similar so that, in the event of an impact, the reinforcer layers exhibit similar behavior and absorb the deformations in a balanced way, thus preventing the premature failure of one or other of said layers on impact with an obstacle.

Likewise, the Young's modulus Ef of the reinforcing elements of each reinforcer layer is preferably at least equal to 85% and at most equal to 110% of the Young's modulus Et of the reinforcing elements of the radially innermost working layer, each of the reinforcers being in its rubberized state extracted from a polymer matrix. Like the preceding condition, this condition allows balanced functioning of the different crown layers, but in this case from the point of view of stresses rather than deformations.

Each extensible metal reinforcing element of each crown layer advantageously has, in its rubberized state extracted from a polymer matrix, a structural elongation at least equal to 1% and at most equal to 3%, which is the optimum range for the structural elongations of the reinforcers of said layers for the best protection against punctures and impacts on the crown. If the structural elongation of said layers is too great, the tire deforms excessively and the rubber materials of the tire also deform significantly on inflation, consuming some of their crack resistance in particular. For rubberized extensible reinforcers extracted from a polymer matrix, a structural elongation of 0.5%, which is a lower limit of structural elongation, is not optimal for improved puncture resistance of the tire.

Likewise, each extensible metal reinforcing element of each crown layer preferably has, in its rubberized state extracted from a polymer matrix, a Young's modulus (Ef, Et) at most equal to 85 GPa and at least equal to 50 GPa, for optimum behavior with respect to crack and puncture resistance performance.

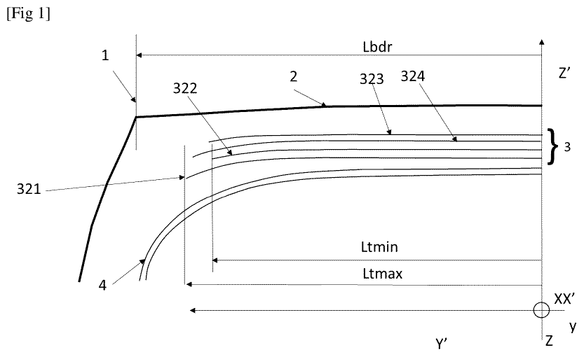

The features of the invention are illustrated in FIG. 1, which is schematic and not to scale, with reference to a tire of size 24.00R35, showing a meridian cross-section of a tire crown according to the invention comprising four crown layers.

FIG. 1 does not show all of the possibilities offered by the invention. For example, for a version of the invention comprising two working layers and one hooping layer, there are a number of possible variants of the positioning of the different hooping and triangulation layers included in the invention that are not shown.

FIG. 1 shows a meridian cross-section of a tire 1 for a heavy-duty civil engineering vehicle comprising a crown reinforcement 3 radially inside a tread 2 and radially outside a carcass reinforcement 4. The crown reinforcement 3 comprises crown layers 321, 322, 323, 324, at least two of which are working layers. All of the crown layers 321, 322, 323, 324 comprise extensible metal reinforcers coated in an elastomeric material and parallel to each other. For the working layers, the reinforcers form an angle of between 10° and 45° with a circumferential direction XX′ tangential to the circumference of the tire, and crossed from one layer to the next. The axial width of the tread Lbdr, and the minimum and maximum axial widths Ltmin and Ltmax respectively of the working layers are also shown.

The invention was tested on tires of size 24.00R35 with a 590 mm axial tread width. The tires according to the invention were compared with reference tires of the same size for each of the tests.

With respect to the puncture resistance performance of the crown, quasi-static tests were carried out using a cylindrical indenting tool 300 mm long, with a circular base with a diameter of 76.6 mm, the end of which, intended to come into contact with the tire, is beveled on symmetrical planes relative to the axis of the cylinder, the tip of the bevel having an angle of 46°.

The quasi-static test consists of pushing the indenting tool in at a speed of 50 mm/min. The tire is compressed on flat ground with a force equal to the recommended load and the tire inflated to the recommended pressure. The indenting tool is pushed in at the center of the contact patch. The result of the test is the penetration distance necessary to break the crown reinforcement. The results are given in base 100, where 100 is the result on the reference tire. A result of more than 100 indicates better performance.

The crack resistance performance of the crown, also known as split resistance of the crown, is measured in tests on a machine in which two tires of the same type (reference tire on reference tire, tire according to the invention on tire according to the invention) run on each other at a speed of 28 km/h, with the tires inflated to 7.25 bar for a compressive force of 20 t. The test is stopped when one of the tires loses pressure. The result is the number of kilometers traveled before the failure of the tire.

The reference tires and the tires according to the invention are identical apart from the crown reinforcement. They have the same tread pattern and the same reinforcers for the carcass layer and the same rubber compounds for the different parts of the tire.

With respect to the crown reinforcement, radially from outside to inside, the reference tires are made up of a protective reinforcement, a working reinforcement, and a hoop reinforcement.
The reinforcing elements of the protective layers are E24.26 extensible cords (24 threads with a diameter of 26 hundredths of a millimeter), with a laying pitch of 2.5 mm, the structural elongation As of which, in their rubberized state extracted from a polymeric matrix, is equal to 0.6%, the total elongation at break At of which is equal to 3.9% and the Young's modulus of which is equal to 75 GPa. They form an angle of 24° with the circumferential direction and are crossed from one layer to the next. The radially outermost layer has an axial width of 520 mm, and the other layer has an axial width of 400 mm
The reinforcing elements of the working layers are 26.30 inextensible cords (26 threads with a diameter of 30 hundredths of a millimeter), with a laying pitch of 3.4 mm, the structural elongation As of which, in their rubberized state extracted from a polymeric matrix, is equal to 0%, the total elongation at break At of which is equal to 2.4% and the Young's modulus of which is equal to 180 GPa. The radially innermost layer forms an angle of −33° and the radially outermost layer forms an angle of 19° with the circumferential direction and they are crossed from one layer to the next. The radially outermost layer has an axial width of 380 mm, and the other layer has an axial width of 450 mm.
The reinforcing elements of the hooping layers are identical to the reinforcing elements of the working layers with the same laying pitch. They form an angle of 8° with the circumferential direction and are crossed from one layer to the next. They are laid in the form of a ply. The radially outermost layer has an axial width of 200 mm, and the other layer has an axial width of 240 mm.

Due to the stiffness of the working layers and the hooping layers, it is not possible to make the hooping layers wider. If only the hooping layers are extensible, they are no longer effective.

Two versions of the invention were tested, a so-called extensible version referred to as E and two so-called hyperextensible versions referred to as HE1 and HE2, HE2 having more hyperextensible reinforcers than HE1. For the three versions E, HE1 and HE2 of the invention, the architecture of the crown reinforcement is identical but the reinforcing elements of the different crown layers are different. Radially from outside to inside, the crown reinforcement is made up of:
A working layer forming an angle of 33° with the circumferential direction, having an axial width of 380 mm, i.e. 64% of the tread width,
A working layer forming an angle of −33° with the circumferential direction, having an axial width of 450 mm, i.e. 76% of the tread width,
A working layer forming an angle of 33° with the circumferential direction, having an axial width of 380 mm, i.e. 64% of the tread width,
A working layer forming an angle of −33° with the circumferential direction, having an axial width of 450 mm, i.e. 76% of the tread width.

For version E of the invention, all of the layers of the crown reinforcement are produced with reinforcers consisting of E21.28 cords (21 threads with a diameter of 28 hundredths of a millimeter) laid at a pitch of 2.4 mm, the structural elongation As of which, in their rubberized state extracted from a polymer matrix, is equal to 0.5%, the total elongation at break At of which is equal to 3.3% and the Young's modulus of which is equal to 95 GPa.

For version HE1 of the invention, all of the layers of the crown reinforcement are produced with reinforcers consisting of E24.35_1 cords (24 threads with a diameter of 35 hundredths of a millimeter) laid at a pitch of 3.9 mm, the structural elongation As of which, in their rubberized state extracted from a polymer matrix, is equal to 1.1%, the total elongation at break At of which is equal to 4.3% and the Young's modulus of which is equal to 70 GPa. The elasticity and hyperelasticity, in other words the extensible and hyperextensible nature of the cords, are obtained by adjusting the arrangement of the threads in the cord and also the compound placed between the threads.

For version HE2 of the invention, all of the layers of the crown reinforcement are produced with reinforcers consisting of E24.35_2 cords (24 threads with a diameter of 35 hundredths of a millimeter) laid at a pitch of 4.2 mm, the structural elongation As of which, in their rubberized state extracted from a polymer matrix, is equal to 1.6%, the total elongation at break At of which is equal to 5.5% and the Young's modulus of which is equal to 50 GPa. The elasticity and hyperelasticity of the cords are obtained by adjusting the arrangement of the threads in the cord and also the compound placed between the threads.

The modulus of elasticity during the phase of structural elongation of the assembly of the extensible or hyperextensible cords of the reference tires or the tires according to the invention is between 10 and 20 GPa in their non-rubberized state, and between 10 and 30 GPa in their rubberized state extracted from a polymer matrix.

With respect to the penetration resistance performance, the results show that, despite the reduction of the weight of the tire by reducing the metal mass of its crown reinforcement, the critical height of the indenting tool during an impact on the surface of the tread is significantly greater. Version E exhibits identical performance to the control tire, version HE1 exhibits a 10% improvement, and version HE2 a 20% improvement.

With respect to the tests relating to cracking or splitting of the crown, the tires according to the invention traveled an identical number of kilometers to the reference tire before failure, exhibiting identical performance.

With respect to performance relating to the mass of the tires, versions E and HE1 exhibit a 20% reduction in metal mass and version HE2 a 22% reduction, which for the tire tested is a reduction in mass of approximately 100 kg.

The invention as proposed therefore allows, for identical or improved crown puncture resistance, identical crack resistance of the crown reinforcement and a reduction in the mass of the crown reinforcement and therefore the mass of the tire.

1. A radial tire for a civil engineering vehicle, comprising:
a crown reinforcement, radially inside a tread having an axial width Lbdr and radially outside a carcass reinforcement and comprising crown layers having metal reinforcing elements,
the crown reinforcement comprising at least one working reinforcement, comprising at least two working layers, one with a larger axial width having an axial width Ltmax and one with a smaller axial width having an axial width Ltmin,
each working layer comprising metal reinforcing elements parallel to each other, forming oriented angles at least equal to 10° and at most equal to 45° with the circumferential direction, at least two angles of two working layers being of opposite signs,
each reinforcing element of each of the crown layers being characterized by a structural elongation As, a force at break Fm (maximum load in N), a breaking strength Rm (in MPa), a total elongation at break At and a tensile Young's modulus E, these characteristics being measured in accordance with ASTM D 2696-04 of 2014,
wherein each metal reinforcing element of each crown layer is extensible and has, in its rubberized state extracted from a polymer matrix, a structural elongation As at least equal to 0.5%, a total elongation at break At at least equal to 3% and a tensile Young's modulus E at most equal to 150 GPa,
wherein the axial width Ltmin of the working layer with a smaller axial width (322) is at least equal to 60% of the axial width Lbdr of the tread (Ltmin≥0.6*Lbdr),
wherein the axial width Ltmax of the working layer with a larger axial width (321) is at least equal to 70% of the axial width Lbdr of the tread (Ltmax≥0.7*Lbdr).

2. The tire as claimed in claim 1, wherein the crown reinforcement consists of two working layers and a third transverse reinforcer crown layer in which the extensible metal reinforcers form an angle of between 5° and 70° with the circumferential direction.

3. The tire as claimed in claim 1, wherein the crown reinforcement consists of four working layers.

4. The tire as claimed in claim 1, wherein the crown reinforcement comprises three working layers and a transverse reinforcer crown layer wherein the extensible reinforcers form an angle of between 5° and 70° with the circumferential direction, the angles of the reinforcers with the circumferential direction being of opposite signs from one working layer to the next.

5. The tire as claimed in claim 1, wherein the crown reinforcement consists of two working layers.

6. The tire as claimed in claim 1, wherein the structural elongation at break As of the reinforcing elements of each crown layer is at least equal to 85% and at most equal to 110% of the structural elongation Ast of the reinforcing elements of the radially innermost working layer (321), each of the reinforcers being in its rubberized state extracted from a polymer matrix.

7. The tire as claimed in claim 1, wherein the Young's modulus Ef of the reinforcing elements of each crown layer is preferably at least equal to 85% and at most equal to 110% of the Young's modulus Et of the reinforcing elements of the radially innermost working layer (0.85*Et≤Ef≤1.10*Et), each of the reinforcers being in its rubberized state extracted from a polymer matrix.

8. The tire as claimed in claim 1, wherein each extensible metal reinforcing element of each crown layer has, in its rubberized state extracted from a polymer matrix, a structural elongation at least equal to 1% and at most equal to 3%.

9. The tire as claimed in claim 1, wherein each extensible metal reinforcing element of each crown layer has, in its rubberized state extracted from a polymer matrix, Young's modulus (Ef, Et) at most equal to 85 GPa and at least equal to 50 GPa.

10. The tire as claimed in claim 1, wherein the crown reinforcement comprises at least three crown layers, and the reinforcing elements of the radially outermost crown layer have a structural elongation Asp at least equal to one percent plus the structural elongation Ast of the reinforcing elements of the radially innermost working layer (Asp≥Ast+1%), each of the reinforcers being in its rubberized state extracted from a polymer matrix.
